(19) United States
(12) Patent Application Publication
(10) Pub. No.: US 2016/0014504 A1
(43) Pub. Date: Jan. 14, 2016

(54) HANDHELD COMMUNICATION DEVICE WITH A MULTI-ELECTROACOUSITC TRANSDUCER CONFIGURATION AND A REDUCED FORM FACTOR

(71) Applicant: HARRIS CORPORATION, Melbourne, FL (US)

(72) Inventors: Bryce Tennant, Rochester, NY (US); Todd Bogumil, Rochester, NY (US); Keith Kripp, Pittsford, NY (US); Andrew Fitzgerald, East Rochester, NY (US); Aurora Kiehl, Rochester, NY (US)

(21) Appl. No.: 14/326,998

(22) Filed: Jul. 9, 2014

(51) Int. Cl. H04R 1/32

(52) U.S. Cl. CPC H04R 1/323; H04R 2499/11; H04R 2499/15

(57) ABSTRACT

Systems (300) and methods (1100) for providing audio output from a handheld Communication Device (“CD”). The methods comprise: receiving an audio signal at CD; and dividing the audio signal into a first audio signal with a first frequency bandwidth and a second audio signal with a second frequency bandwidth exclusive of and lower than the first frequency bandwidth. Next, a first electroacoustic transducer (402) produces directional sound in response to the first audio signal. A second electroacoustic transducer (404) produces omnidirectional sound in response to the second audio signal. The first electroacoustic transducer is located on a first side (406) of CD which comprises at least one input device (320, 340) of a user interface (330) that has a stacked arrangement with the first electroacoustic transducer. The second electroacoustic transducer is located on a second side (408) opposed from the first side of the communication device.

### BACKGROUND

1. Statement of the Technical Field

The inventive arrangements relate to handheld communication devices. More particularly, the inventive arrangements concern handheld communication devices with multi electroacoustic transducer configurations and reduced form factors.

2. Description of the Related Art

There are various handheld communication devices known in the art. Such handheld communication devices comprise handheld radios. Handheld radios typically require high quality audio and relatively large display screens, keypads, and navigation buttons. Simple operation of the radio requires a single side user interface. In this regard, all human interface components of the single side user interface are typically presented on the front side of the radio. Such a “single side user interface” restriction limits the ability to significantly reduce the overall height of the radio without sacrificing user experience.

In recent years, there has been an increasing desire to reduce the form factors of radios and other handheld communication devices, without compromising overall performance or user experience. As such, many solutions have been derived which attempt to provide a handheld communication device with a reduced form factor and acceptable overall performance. Despite the advantages of these solutions, they suffer from certain drawbacks. For example, such solutions typically sacrifice one or more of the following device features: display screen size; audio quality; and/or number of input devices. This is evident from the solution described in U.S. Pat. No. 8,320,585 to Gruenhagen et al. (“the '585 patent”).

The solution of the '585 patent comprises introducing a dual facing radio concept (a data side and an audio side) on a handheld communication device. Here, a loudspeaker is located on a first side (or audio side) of the handheld communication device. The display screen and keypad are located on a second opposing side (or data side) of the handheld communication device. Thus, the radio of the '585 patent comprises two active sides of user interface. In this case, audio quality originating from the first side (or audio side side) is sacrificed when a user is using the data side since his/her hand may at least partially cover the loudspeaker and high frequencies are attenuated due to directivity losses. Also, such a dual sided arrangement has the ability to confuse a user thereof since the radio must be flipped between the data side and the audio side when sequentially performing data operations and high quality audio operations.

In order to address the sacrifice of audio quality of the loudspeaker, a secondary speaker will be provided on the data side of the handheld communication device. The secondary speaker is provided to balance the full band audio output (i.e., high, mid and low frequency audio) from the primary speaker disposed on the audio side of the handheld communication device. In this regard, it should be understood that audio is virtually omnidirectional for wavelengths greater than the diameter of a speaker cone. As the audio wavelengths become smaller than the diameter of the speaker cone, the audio become more directional. Stated differently, low frequency audio is perceived as omnidirectional because the speaker diameter is typically smaller than the low frequency wavelengths. In contrast, high frequency audio is perceived as directional because the speaker diameter is typically greater than the high frequency wavelengths. Accordingly, some of the directional high frequency audio characteristics of the handheld communication device are attenuated when the user is using the data side and full band audio is output from the primary speaker located on the opposing audio side. To compensate for such audio loss, the secondary speaker is designed to reproduce the directional high frequency audio output from the primary speaker.

### SUMMARY OF THE INVENTION

The invention concerns implementing systems and methods for providing audio output from a handheld communication device. The methods comprise: receiving an audio signal at the handheld communication device; and dividing the audio signal into a first audio signal and a second audio signal. The first audio signal has a first frequency bandwidth (e.g., 2,000 Hz to 16 kHz). The second audio signal has a second frequency bandwidth exclusive of and lower than the first frequency bandwidth (e.g., 200 Hz to 2,000 Hz). Next, a first electroacoustic transducer produces directional sound in response to the first audio signal. Similarly, a second electroacoustic transducer produces omnidirectional sound in response to the second audio signal. The first electroacoustic transducer is located on a first side of the handheld communication device which comprises at least one input device of a user interface. The input device has a stacked arrangement with the first electroacoustic transducer. The second electroacoustic transducer is located on a second side opposed from the first side of the handheld communication device.

Notably, the second electroacoustic transducer can have an overall size that is larger than an overall size of the first electroacoustic transducer. Also, the first electroacoustic transducer may comprise a tweeter. The second electroacoustic transducer may comprise a woofer. In other scenarios, the first and second electroacoustic transducers may alternatively he used in a passive radiator configuration (as opposed to a woofer/tweeter configuration).

In some scenarios, a structure (e.g., a receiver for a belt clip and/or a radio holster) is provided to prevent a user of the handheld communication device from covering the second electroacoustic transducer. This structure protrudes out and away from the second side of the handheld communication device so as to at least partially cover the second electroacoustic transducer. As such, at least one audio port can he provided for allowing the omnidirectional sound to pass through the structure. For example, an audio port can be formed through at least one sidewall of the structure which is angled relative to a surface defining the second side of the handheld communication device. Additionally or alternatively, at least two audio ports can be formed through different sidewalls of the structure so as to have different orientations relative to a surface defining the second side of the handheld communication device.

In these and other scenarios, at least one audio port may be formed through a contoured surface at least partially defining the second side of the handheld communication device so as to be adjacent to a sidewall of the structure. Additionally or alternatively, at least two audio ports may be formed through one or more contoured surfaces at least partially defining the second side of the handheld communication device so as to have different orientations relative to each other.

### BRIEF DESCRIPTION OF THE DRAWINGS

Embodiments will he described with reference to the following drawing figures, in which like numerals represent like items throughout the figures, and in which:

FIG. 1 is a schematic illustration of a conventional handheld communication device that is useful for understanding the invention.

FIG. 2 is a cross sectional view of the conventional handheld communication device shown in FIG. 1 taken along line 1-1.

FIG. 3 is a block diagram of an exemplary handheld communication device that is useful for understanding the present invention.

FIG. 4 is a schematic illustration of an exemplary hardware architecture for the handheld communication device of FIG. 3.

FIG. 5 is a cross sectional view of the handheld communication device shown in FIGS. 3 and 4 that is useful for understanding the present invention.

FIGS. 6-10 provide various schematic illustrations of another exemplary architecture for a handheld communication device that is useful for understanding the present invention.

FIG. 11 is a flow diagram of an exemplary method for providing audio output from a handheld communication device in accordance with the present invention.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment,

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

100221 Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

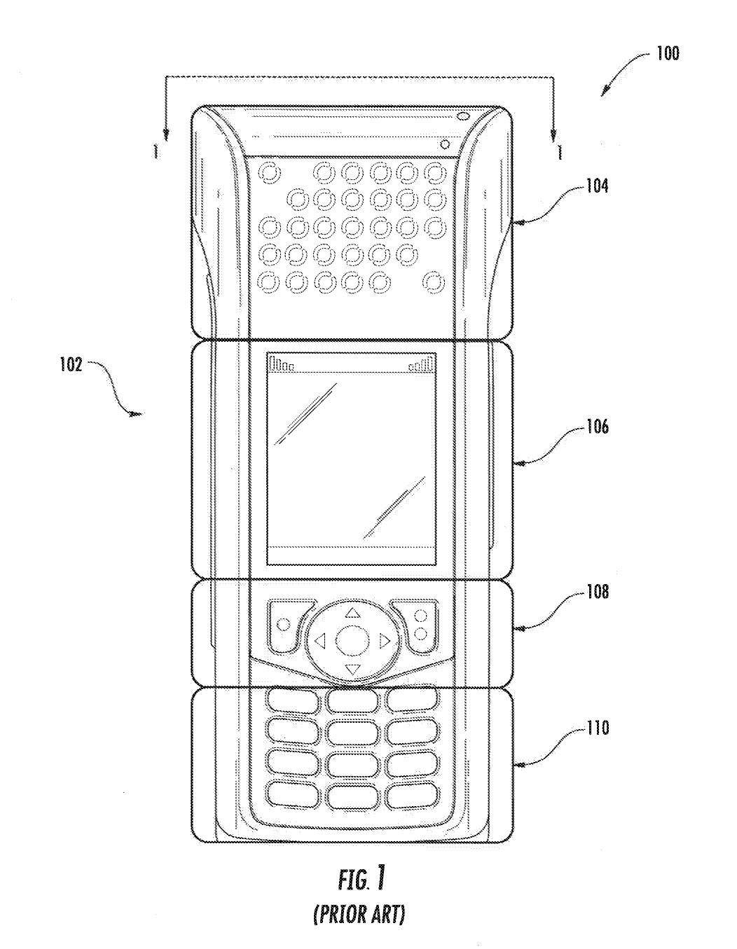

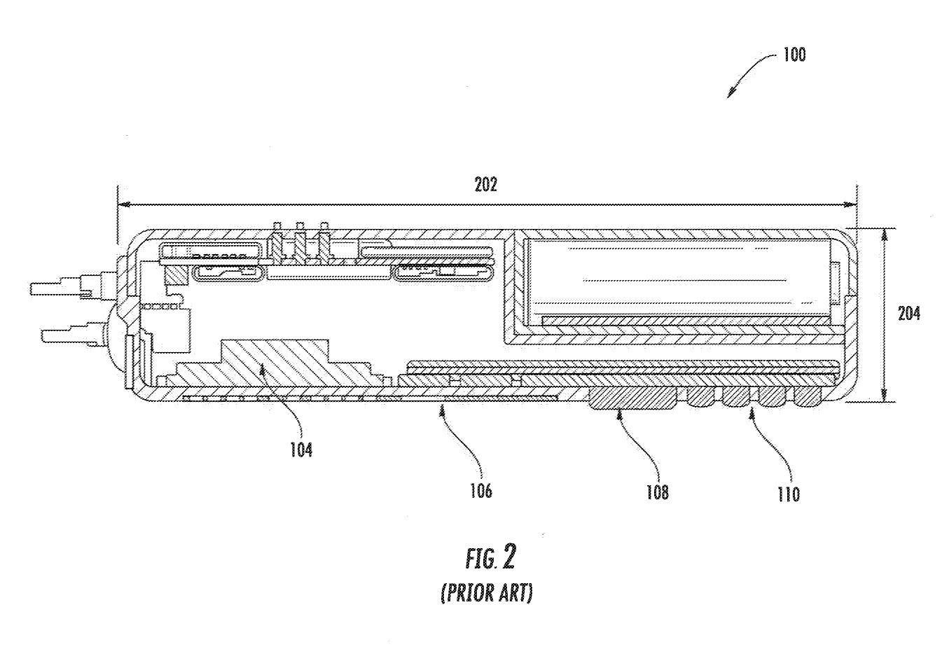

The present invention concerns systems and methods for delivering high quality audio using a handheld communication device with a multi-electroacoustic transducer configuration in a reduced form factor. Currently, conventional handheld communication devices 100 have a single side user interface 102, as shown in FIGS. 1-2. The user interface 102 comprises a relatively large electroacoustic transducer 104, a display screen 106, navigation keys 108 and a keypad 110. These components 104-110 have a stacked arrangement, and therefore define the overall height of the handheld communication device 100. The electroacoustic transducer 106 is generally provided to project received audio signals at low, mid and high frequencies. In order to reduce the overall height of the handheld communication device 100 compromises need to be made on the product. Typically, such compromises result in a reduction in the audio quality provided by the electroacoustic transducer 106, a decrease in the size of the display screen 106, an elimination of the navigation keys 108, and/or a reduction in the size of the keypad 110. The reduction in the audio quality may result from limited size, poor location, poor porting, and other factors. In contrast, the present invention provides a solution for reducing the overall size of a handheld communication device without any or minor such compromise. Notably in the minor compromise scenarios, any degradation in performance is imperceptible. The manner in which the present solution achieves these features will become more evident as the discussion progresses.

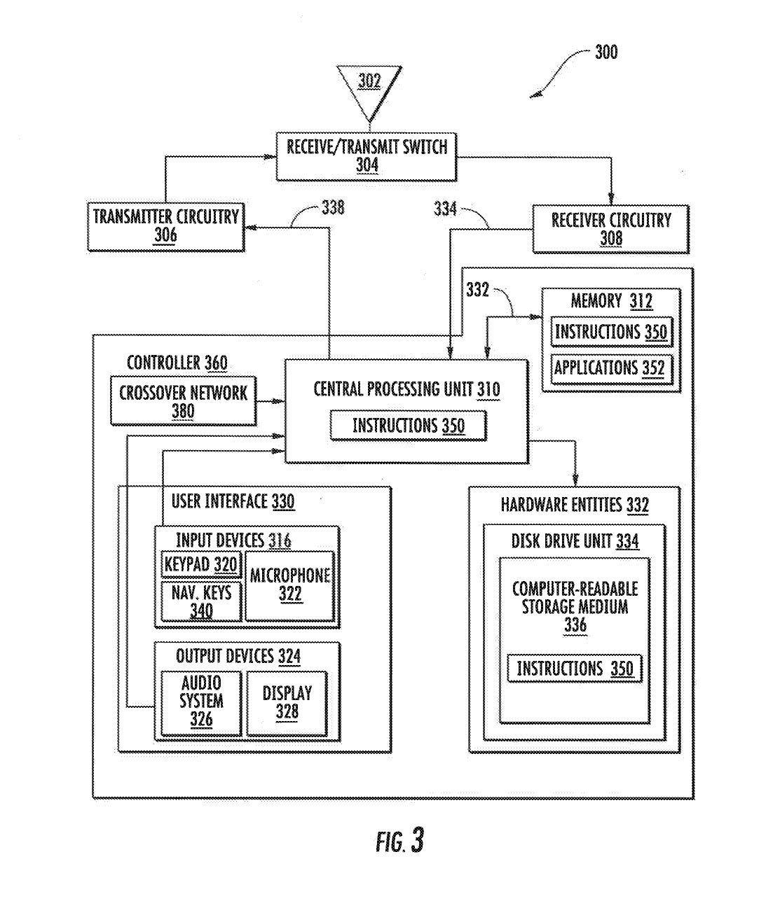

Referring now to FIG. 3, there is provided a block diagram of an exemplary architecture for a handheld communication device 300 which is useful for understanding the present invention. The handheld communication device 300 can include, but is not limited to, a radio, a cellular phone, a mobile phone, a personal digital assistant, a laptop computer, a tablet, or a hybrid tablet/computer device.

Notably, some or all the components of the handheld communication device 300 can be implemented as hardware, software and/or a combination of hardware and software. The hardware includes, but is not limited to, one or more electronic circuits. The electronic circuits can include passive components (e.g., speakers, capacitors, and resistors) and active components (e.g., amplifiers and processors). The passive and/or active components can be arranged to, adapted to and/or programmed to perform one or more functions of the handheld communication device 300.

The handheld communication device 300 may include more or less components than those shown in FIG. 3. However, the components shown are sufficient to disclose an illustrative embodiment implementing the present invention. The hardware architecture of FIG. 3 represents one embodiment of a representative handheld communication device 300 which has a multi-electroacoustic transducer arrangement and a reduced form factor.

As shown in FIG. 3, the handheld communication device 300 comprises an antenna 302 for receiving and transmitting communication signals over a network communications link. A receive/transmit (Rx/Tx) switch 304 selectively couples the antenna 302 to the transmitter circuitry 306 and receiver circuitry 308 in a manner familiar to those skilled in the art. Although a single antenna 302 and transceiver 304/306/308 is shown in FIG. 3, the present invention is not limited in this regard. The handheld communication device 300 can alternatively comprise a first antenna and a first transceiver for handling telephony communications, as well as a second antenna and a second transceiver for handling PTT communications.

The receiver circuitry 308 decodes the communication signals received from an external communication device to derive information therefrom. The receiver circuitry 308 is coupled to a controller 360 via an electrical connection 334. The receiver circuitry 308 provides decoded communication signal information to the controller 360. The controller 360 uses the decoded communication signal information in accordance with the function(s) of the handheld communication device 300. The controller 360 also provides information to the transmitter circuitry 306 for encoding information and/or modulating information into communication signals. Accordingly, the controller 360 is coupled to the transmitter circuitry 306 via an electrical connection 338. The transmitter circuitry 306 communicates the communication signals to the antenna 302 for transmission to an external device.

The controller 360 stores the decoded signal information in its internal memory 312. Accordingly, the controller 360 comprises at least one Central Processing Unit (“CPU”) 310. The CPU(s) may include, but is(are) not limited to, a General Purpose Processor (“GPP”) and/or a Digital Signal Processor (“DSP”). The GPP is generally responsible for managing the transmission and reception of the radio information. In this case, the DSP converts an over-the-air RF signal into an audio signal presented to an operator. Important to this invention is the DSPs responsibility to convert the audio into two meaningful signals that can be handled by the woofer/tweeter combination.

The CPU is connected to and able to access the memory 312 through an electrical. connection 332. The memory 312 can be a volatile memory and/or a non-volatile memory. For example, the memory 312 can include, but is not limited to, a Random Access Memory (“RAM”), a Dynamic Random Access Memory (“DRAM”), a Static Random Access Memory (“SRAM”), Read-Only Memory (“ROM”) and flash memory. The memory 312 can also have stored therein software applications 352 and/or instructions 350. The software applications 352 include, but are not limited to, applications operative to facilitate network communications.

At least some of the hardware entities 332 perform actions involving access to and use of memory 312. In this regard, hardware entities 332 may include microprocessors, Application Specific Integrated Circuits (“ASICs”) and other hardware. Hardware entities 332 may include a microprocessor programmed for facilitating network communications. In this regard, it should be understood that the microprocessor can access and run applications 352 installed on the handheld communication device 300.

As shown in FIG. 3, the hardware entities 332 can include a disk drive unit 334 comprising a computer-readable storage medium 336 on which is stored one or more sets of instructions 350 (e.g., software code) configured to implement one or more of the methodologies, procedures, or functions described herein. The instructions 350 can also reside, completely or at least partially, within the memory 312 and/or within the CPU 310 during execution thereof by the handheld communication device 300. The memory 312 and the CPU 310 also can constitute machine-readable media. The term “machine-readable media”, as used here, refers to a single medium or multiple media (e.g., a centralized or distributed database, and/or associated caches and servers) that store the one or more sets of instructions 350. The term “machine-readable media”, as used here, also refers to any medium that is capable of storing, encoding or carrying a set of instructions 350 for execution by the handheld communication device 300 and that cause the handheld communication device 300 to perform any one or more of the methodologies of the present disclosure.

The user interface 330 comprises input devices 316 and output devices 324. The input devices 316 include, but are not limited to, a keypad 320, navigation keys 340, a microphone 322, and buttons (not shown). The keypad 320, navigation keys 340, and buttons can enable user-software interactions to control operations of the handheld communication device 300. Each of the listed input devices is well known in the art., and therefore will not be described herein. Any known or to be known input device suitable for a particular application can be used with the present invention without limitation.

The output devices 324 include, but are not limited to, an audio system 326 and a display 328. During operation, one or more GUIs may be presented to the user of the handheld communication device 300 via the display 328. For example, a GUI may be displayed on display 328 for enabling a user-software interaction to initiate a call.

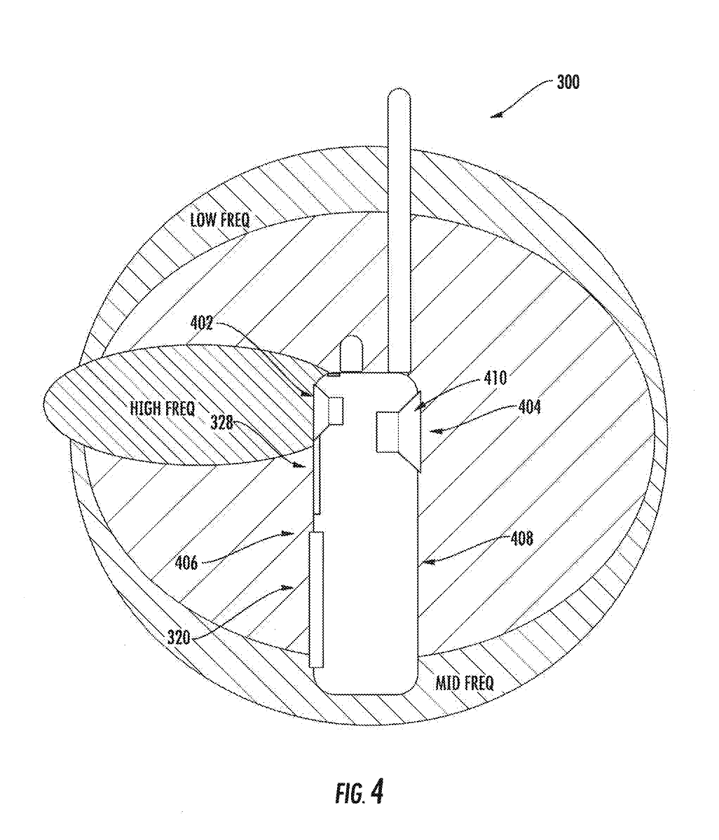

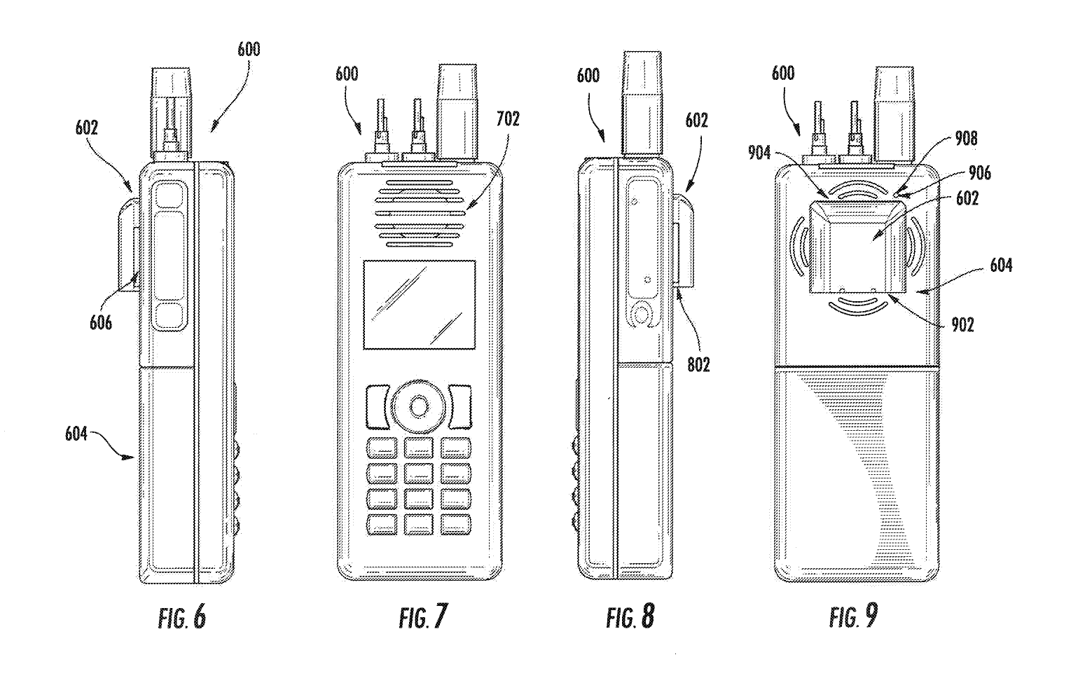

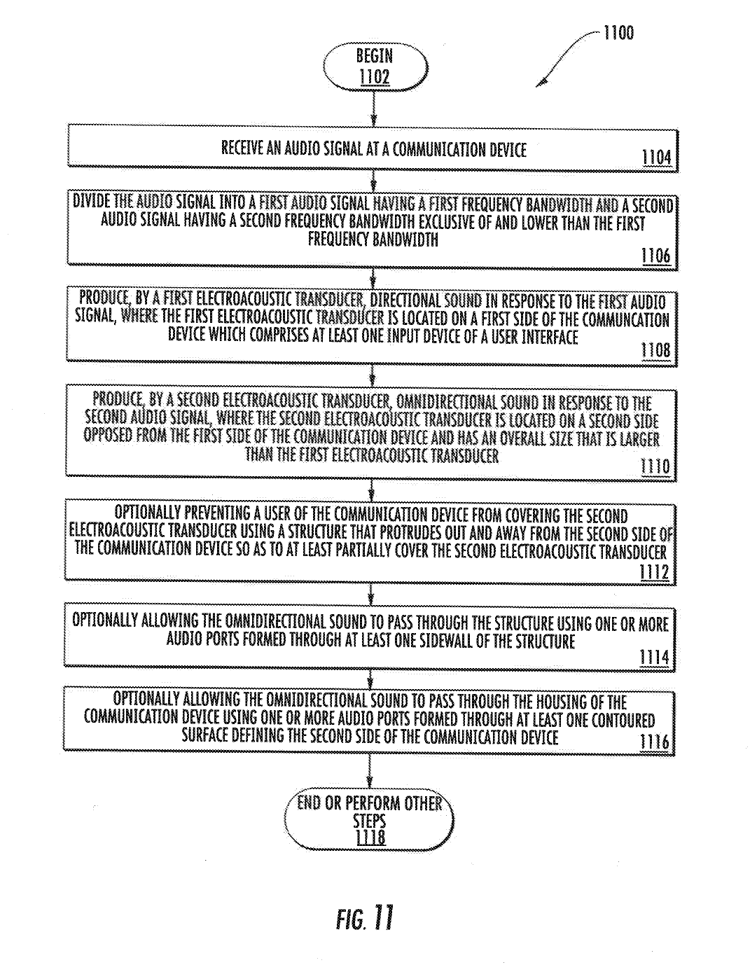

Notably, various hardware components of the user interface 330 are arranged to facilitate the reduced form factor of the handheld communication device 300. As such, the discussion provided below in relation to FIGS. 4-10 is directed towards exemplary novel hardware architectures for the,handheld communication device 300.

Referring now to FIGS. 3-5, the audio system 326 of the handheld communication device 300 comprises two electroacoustic transducers and an audio cross over network 380 such that a user of the handheld communication device 300 has a full frequency band audio experience. The two electroacoustic transducers include a first electroacoustic transducer 402 and a second electroacoustic transducer 404. The first electroacoustic transducer 402 is located on a first side 406 of the handheld communication device 300, while the second electroacoustic transducer 404 is located on a second side 408 opposed from the first side 406 of the handheld communication device 300. This two electroacoustic transducer arrangement has certain advantages. For example, the overall audio quality and perceived loudness of the communication device is improved as compared to conventional communication devices. This will become more evident as the discussion progresses.

In order to reduce the overall height of the handheld communication device 300, the stacked arrangement of a relatively large speaker, display screen 312, keypad 314 and navigation keys 340 was eliminated. In this regard, the size of electroacoustic transducer 402 may be reduced as compared to that of conventional communication devices. Consequently, the handheld communication device 300 has a stacked arrangement of a relatively small electroacoustic transducer 402, display screen 312, keypad 314 and navigation keys. This stacked arrangement enables the reduction in the overall height 502 of the handheld communication device 300 as compared to the overall height 202 the handheld conventional communication device 100 (e.g., by at least 20 mm), while maintaining the same or substantially similar the overall width 204, 504 and user audio experience.

Notably, the first electroacoustic transducer 402 is designed to produce directional high frequency audio. Therefore, the first electroacoustic transducer 402 acts as or similar to a tweeter. The term “tweeter”, as used herein, refers to a loudspeaker intended to be used for audio frequencies from around 2,000 Hz to 16 KHz. In some scenarios, the first electroacoustic transducer 402 comprises an electrodynamic driver which uses a voice coil suspended within a fixed magnetic field. Such a design operates by applying a current from the output of an amplifier circuit to the voice coil. Embodiments of the present invention are not limited to the particulars of such a first electroacoustic transducer architecture. Any known or to be known loudspeaker or tweeter architecture can be used herein without limitation.

However, as a result of this first electroacoustic transducer design, the communication device experiences loss in relation to its low frequency audio characteristic. Therefore, the second electroacoustic transducer 404 is designed to compensate for the loss in the low frequency audio by at least being larger in size as compared to that of the first electroacoustic transducer 402. Notably, the relatively large electroacoustic transducer 404 offers better response and perceived volume as compared to that offered by the relatively small electroacoustic transducer 402. The second electroacoustic transducer 404 is also omnidirectional for wavelengths at or greater than the diameter of the transducer cone 410, as shown in FIG. 4. In this regard, the second electroacoustic transducer 404 produces omnidirectional low frequency audio which provides the increased perceived loudness of the audio system 326 and the improved bass response of the audio system 326 on the first side 406 of the communication device 300. The second electroacoustic transducer 404 may also produce mid frequency audio. Thus, the second electroacoustic transducer 404 acts as or similar to a woofer. The term “woofer”, as used herein, refers to a loudspeaker designed to produce low frequency sounds and/or mid frequency sounds. Such sounds have a frequency at least from 200 Hz to 2,000 Hz, and in some cases 100 Hz to 2,000 Hz.

As noted above, a crossover network 380 is provided within the handheld communication device 300. The crossover network 380 comprises at least one electronic filter for use in audio applications. During operation, the electronic filter(s) split(s) an audio signal into separate frequency bands that can be separately routed to the first and second electroacoustic transducers 402, 404, which are optimized for their respective frequency bands. In some scenarios, the audio signal is divided by the crossover network 380 prior to or subsequent to any amplification thereof. The crossover network 380 may also perform other signal processing operations, such as limiting, delay and equalization. Crossover networks are well known in the art. Any known or to be known crossover network that is suitable for a particular application can be used herein without limitation. Still, it should be understood that the crossover network can be implemented in both analog and digital software. Crossover networks should also not be limited to fixed frequency, but can be adjustable, adaptable, configurable, and/or have common frequency bands that overlap.

The result of such a crossover network 380 and audio system 326 arrangement is an attenuation of high frequency audio relative to the first side 406 (or front) of the handheld communication device 300 for audio signals emitted from the second side 408 (or rear) of the handheld communication device 300. As a result of this attenuation, audio will sound most natural from only the first side 406 of the handheld communication device 300,

Also, the handheld communication device 300 has an audio characteristic which spans a larger frequency range as compared to conventional communication devices. For example, audio output of conventional communication devices typically spans a frequency range of 300 Hz to 4 KHz. In contrast, the audio output of handheld communication device 300 spans a frequency range of at least 200 Hz to 16 KHz in some scenarios.

Although the audio system 326 is provided with two electroacoustic transducers 402, 404, the handheld communication device 300 comprises a single side user interface provided on the first side 406 thereof. As such, the present invention overcomes certain drawbacks of conventional handheld communication devices, such as that disclosed in the '585 patent. For example, the present invention eliminates the user confusion caused by having a dual sided user interface (which would be provided on both sides 406, 408 of the handheld communication device rather than exclusively on one side 406).

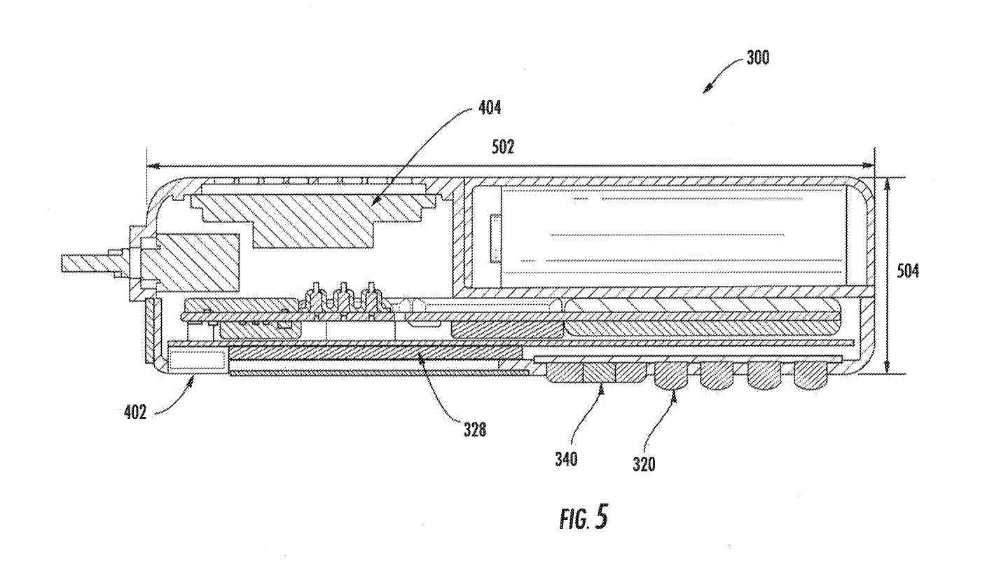

Notably, in some scenarios, the secondary electroacoustic transducer 304 is at least partially hidden from view by the user of the handheld communication device 300. As such, the single side user interface feature of the present invention is visibly clear to a user of the handheld communication device 300, whereby any potential user confusion with regard to the location of the single side user interface is minimized. Exemplary embodiments of a communication device with a hidden secondary electroacoustic transducer will be described below in relation to FIGS. 6-10.

Referring now to FIGS. 6-10, there are provided schematic illustrations of an exemplary architecture for a handheld communication device 600 implementing the present invention. The handheld communication device 600 comprises a first electroacoustic transducer 702, a second electroacoustic transducer 1002, and a crossover network (not shown) which are respectively substantially similar to or the same as the first electroacoustic transducer 402, the second electroacoustic transducer 404 and the crossover network 380 described above. As such, the above discussion of components 402, 404 and 380 is sufficient for understanding the corresponding components of communication device 600.

However, unlike the above described second electroacoustic transducer 404 of communication device 300, the second electroacoustic transducer 1002 of communication device 600 is at least partially hidden from view by a structure 602. The structure 602 protrudes out and away from a rear surface 604 of the handheld communication device 600 so as to prevent a user from covering the second electroacoustic transducer 1.002 by placing his/her hand thereover while grasping the communication device. In some scenarios, structure 602 includes, but is not limited to, a receiver for a bell clip and/or a radio holster. Radio holsters, belt clips and associated receivers are known in the art, and therefore will not be described herein. Any known or to be known radio holster, belt clip and receiver configuration suitable for a particular application can be used herein without limitation.

Since structure 602 at least partially covers the second electroacoustic transducer 1002, audio ports 606, 802, 902, 904 are provided through structure 602. The audio ports 606, 802, 902, 904 comprise at least one aperture, slot, hole, or channel through which an audio signal or sound can pass. In this scenario, the audio ports 606, 802, 902, 904 are arranged so as to be in different orientations relative to the structure 602. For example, a first audio port 606 is formed through a left sidewall of the structure 602. A second audio port 802 is formed through a right sidewall of the structure 602. A third audio port 904 is formed through a top sidewall of the structure 602. A fourth audio port 902 is formed through a bottom sidewall of the structure 602. Each sidewall (top, bottom, left and right) can be orthogonal (i.e., 90°) to or angled (0.1°-90°) relative to the rear surface 604 of the handheld communication device 600. Embodiments of the present invention are not limited to the particulars of this exemplary audio port configuration.

Additionally or alternatively, at least one audio port 908 can be provided through a contoured surface 906 that is adjacent to the structure 602 and protrudes out and away from the rear surface 604 of the handheld communication device 600. The contoured surface 906 can include, but is not limited to, an outward facing dimple or a raised ridge. Audio port 908 may comprise at least one aperture, slot, hole, or channel through which an audio signal or sound can pass. Also, audio port 908 can have the same orientation or different orientation relative to the structure 602 as one or more other audio ports 606, 802, 902, 904.

Also, at least one audio port 606, 802, 902, 904 can have a dual purpose: (1) enable audio signals to travel from second electroacoustic transducer 1002 through the housing and/or structure of the handheld communication device 600; (2) enable the removal of dirt, water or other environmental contaminate from within the handheld communication device 600; and (3) providing a thermal vent to dissipate heat generated by the speaker's voice coil.

In view of the forgoing, the present invention provides communication devices with a multi-electroacoustic transducer configuration in a reduced form factor. The multi-electroacoustic transducer configuration is comprised of a tweeter, a woofer and a crossover network which collectively enable: (a) a smaller handheld communication device by removing the mechanical stack-up constraints of a single side user interface without sacrificing audio quality; (b) the use of a smaller electroacoustic transducer on the front of the handheld communication device; (c) an addition of loudness and bass response to the handheld communication device without increasing overall device size; and (d) a maximization of the use of available device space. The present invention also provides a way to eliminate a user's ability to inadvertently block the audio output from the second electroacoustic transducer when grasping the handheld communication device. The rear audio port geometry conceals and protects the second electroacoustic transducer without impacting desired audio performance. The present invention further simplifies the audio capture subsystem of the device because user interaction becomes more predictable.

Referring now to FIG. 11, there is provided a flow diagram of an exemplary method 1101) for providing audio output from a handheld communication device in accordance with the present invention. Method 1100 begins with step 1102 and continues with step 1104. Step 1104 involves receiving an audio signal at the handheld communication device (e.g., communication device 300 of FIG. 3). Next, in step 1106, the audio signal is divided into a first audio signal and a second audio signal. The first audio signal has a first frequency bandwidth (e.g., 2,000 Hz to 16 kHz). The second audio signal has a second frequency bandwidth exclusive of and lower than the first frequency bandwidth (e.g., 200 Hz to 2,000 Hz). Next, in step 1108, a first electroacoustic transducer (e.g., electroacoustic transducer 402 of FIG. 4) produces directional sound in response to the first audio signal. Similarly, in step 1110, a second electroacoustic transducer (e.g., electroacoustic transducer 404 of FIG. 4) produces omnidirectional sound in response to the second audio signal.

Notably, the first electroacoustic transducer is located on a first side of the communication device (e.g., side 406 of FIG. 4) which comprises at least one input device (e.g., keypad 320 or navigation keys 340 of FIG. 3) of a user interface (e.g., user interface 330 of FIG. 3). The input device has a stacked arrangement with the first electroacoustic transducer. The second electroacoustic transducer is located on a second side (e.g., side 408 of FIG. 4) opposed from the first side of the communication device. Also, the second electroacoustic transducer can have an overall size that is larger than an overall size of the first electroacoustic transducer. In this case, the first electroacoustic transducer may comprise a tweeter, and the second electroacoustic transducer may comprise a woofer.

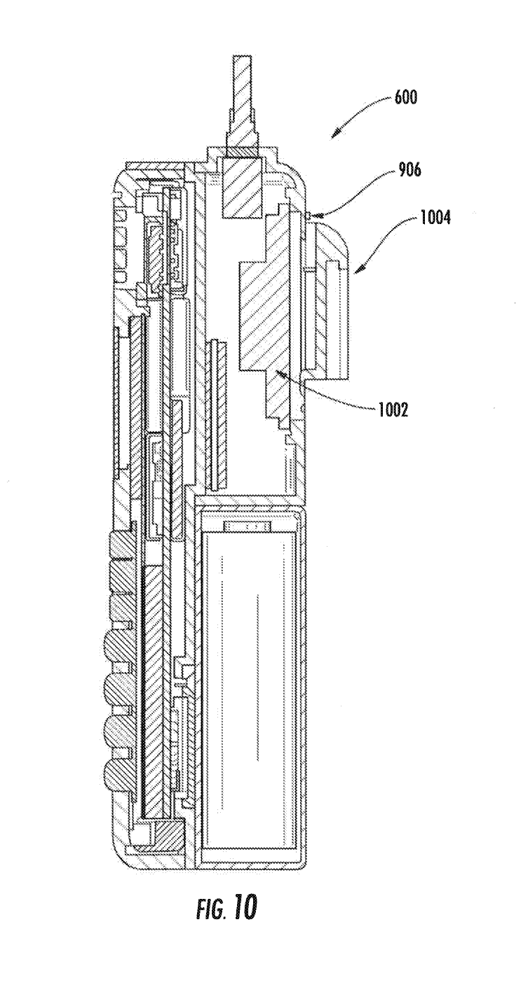

In some scenarios, method 1100 further includes optional steps 1112-1116. Optional step 1112 involves preventing the user from covering the second electroacoustic transducer using a structure (e.g., 602 of FIG. 6) that protrudes out and away from the second side of the communication device so as to at least partially cover the second electroacoustic transducer. The structure can include, but is not limited to, a receiver for a belt clip. Optional step 1114 involves allowing the omnidirectional sound to pass through the structure using one or more audio ports (e,g., audio port 606 of FIG. 6, audio port 802 of FIG. 8, and/or audio port 902, 904 of FIG. 9) formed through at least one sidewall of the structure. The sidewall(s) can be angled relative to a surface defining the second side of the communication device. Additionally or alternatively, the omnidirectional sound can be allowed to pass through a housing of the communication device using one or more audio ports (e.g., audio port 908 of FIG. 9) formed through at least one contoured surface at least partially defining the second side of the communication device so as to be adjacent to a sidewall of the structure, as shown by optional step 1116. If a plurality of audio ports is used in optional step 1114 and/or optional step 1116, then the audio ports can have the same or different orientations relative to each other and/or a surface defining the second side of the communication device. Next, step 1118 is performed where method 1100 ends or other steps are performed.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method for providing audio output from a handheld communication device, comprising:
receiving an audio signal at the handheld communication device;
dividing the audio signal into a first audio signal with a first frequency bandwidth and a second audio signal with a second frequency bandwidth exclusive of and lower than the first frequency bandwidth;
producing, by a first electroacoustic transducer of the handheld communication device, directional sound in response to the first audio signal, the first electroacoustic transducer located on a first side of the handheld communication device which comprises at least one input device of a user interface that has a stacked arrangement with the first electroacoustic transducer; and
producing, by a second electroacoustic transducer of the handheld communication device, omnidirectional sound in response to the second audio signal, the second electroacoustic transducer located on a second side opposed from the first side of the handheld communication device.

2. The method according to claim I, wherein the second electroacoustic transducer has an overall size that is larger than an overall size of the first electroacoustic transducer.

3. The method according to claim 1, wherein the first electroacoustic transducer comprises a tweeter and the second electroacoustic transducer comprises a woofer.

4. The method according to claim I, wherein the dividing is performed by a crossover network of the handheld communication device prior to or subsequent to any amplification of an audio signal.

5. The method according to claim I, further comprising separately routing the first second audio signals respectively to the first and second electroacoustic transducers.

6. The method according to claim 1, further comprising preventing a user of the handheld communication device from covering the second electroacoustic transducer using a structure that protrudes out and away from the second side of the handheld communication device so as to at least partially cover the second electroacoustic transducer.

7. The method according to claim 6, wherein the structure is a receiver for a belt clip.

8. The method according to claim 6, further comprising allowing the omnidirectional sound to pass through the structure using at least one audio port formed through at least one sidewall of the structure which is angled relative to a surface defining the second side of the handheld communication device.

9. The method according to claim 6, further comprising allowing the omnidirectional sound to pass through the structure using at least two audio ports formed through different sidewalls of the structure so as to have different orientations relative to a surface defining the second side of the handheld communication device.

10. The method according to claim 6, further comprising allowing the omnidirectional sound to pass through the housing of the handheld communication device using at least one audio port formed through at least one contoured surface at least partially defining the second side of the handheld communication device so as to be adjacent to a sidewall of the structure.

11. The method according to claim 6, further comprising allowing the omnidirectional sound to pass through the housing of the handheld communication device using at least two audio ports formed through at least one contoured surface at least partially defining the second side of the handheld communication device so as to have different orientations relative to each other.

12. A handheld communication device, comprising:
a crossover network operative to divide an audio signal into a first audio signal with a first frequency bandwidth and a second audio signal with a second frequency bandwidth exclusive of and lower than the first frequency bandwidth;
a first electroacoustic transducer operative to produce directional sound in response to the first audio signal, the first electroacoustic transducer located on a first side of the handheld communication device which comprises at least one input device of a user interface that has a stacked arrangement with the first electroacoustic transducer; and
a second electroacoustic transducer operative to produce omnidirectional sound in response to the second audio signal, the second electroacoustic transducer located on a second side opposed from the first side of the handheld communication device.

13. The handheld communication device according to claim 12, wherein the second electroacoustic transducer has an overall size that is larger than an overall size of the first electroacoustic transducer.

14. The handheld communication device according to claim 12, wherein the first electroacoustic transducer comprises a tweeter and the second electroacoustic transducer comprises a woofer.

15. The handheld communication device according to claim 12, wherein the dividing is performed by the crossover network prior to or subsequent to any amplification of an audio signal.

16. The handheld communication device according to claim 12, wherein the crossover network is further operative to separately route the first second audio signals respectively to the first and second electroacoustic transducers.

17. The handheld communication device according to claim 12, further comprising a structure protruding out and away from the second side of the handheld communication device so as to at least partially cover the second electroacoustic transducer.

18. The handheld communication device according to claim 17, wherein the structure is a receiver for a belt clip or radio holster.

19. The handheld communication device according to claim 17, further comprising at least one audio port formed through at least one sidewall of the structure which is angled relative to a surface defining the second side of the handheld communication device.

20. The handheld communication device according to claim 17, thither comprising at least two audio ports formed through different sidewalls of the structure so as to have different orientations relative to a surface defining the second side of the handheld communication device.

21. The handheld communication device according to claim 17, further comprising at least one audio port formed through at least one contoured surface at least partially defining the second side of the handheld communication device so as to be adjacent to a sidewall of the structure.

22. The handheld communication device according to claim 17, further comprising at least two audio ports formed through at least one contoured surface at least partially defining the second side of the handheld communication device so as to have different orientations relative to each other.
